(19) United States
(12) Patent Application Publication
(10) Pub. No.: US 2014/0236939 A1
(43) Pub. Date: Aug. 21, 2014

(54) SYSTEMS AND METHODS FOR TOPICAL GROUPING OF SEARCH RESULTS AND ORGANIZING OF SEARCH RESULTS

(71) Applicant: Stremor Corporation, Scottsdale, AZ (US)

(72) Inventors: Brandon Wirtz, Phoenix, AZ (US); William Irvine, Scottsdale, AZ (US)

(73) Assignee: Stremor Corporation, Scottsdale, AZ (US)

(21) Appl. No.: 14/216,753

(22) Filed: Mar. 17, 2014

Related U.S. Application Data
(63) Continuation-in-part of application No. 13/772,000, filed on Feb. 20, 2013.
(60) Provisional application No. 61/799,227, filed on Mar. 15, 2013.

(51) Int. Cl. G06F 17/30

(52) U.S. Cl. CPC G06F 17/30554
USPC 707/728; 707/722

(57) ABSTRACT

Embodiments include a method for providing two or more search results. The method can include receiving at least one search parameter from a search query of a first user. The method also can include determining potential search results based upon the at least one search parameter. The method further can include determining one or more related searches from one or more second users. The method also can include determining two or more search results at least partially based upon the at least one search parameter and the one or more related searches. The method additionally can include determining that the two or more search results are related to a topic. The method further can include organizing the two or more search results based upon the topic. The method also can include displaying the two or more search results to the first user. Other embodiments are disclosed.

### CROSS-REFERENCE TO RELATED APPLICATIONS

This application claims the benefit of U.S. Provisional Application No. 61/799,227 filed Mar. 15, 2013. This application is also a continuation-in-part of U.S. application Ser. No. 13/772,000, filed Feb. 20, 2013. U.S. Provisional Application No. 61/799,227 and U.S. application Ser. No. 13/772,000 are incorporated herein by reference in their entirety.

### TECHNICAL FIELD

This invention relates generally to computer aided searching of information, and relates more particularly to computer systems and methods for grouping and organizing searching of information.

### BACKGROUND

People often search for documents on the Internet using search engines. Many search engines attempt to find the desired document from the multitude of information available on the web. Users often submit queries to the search system, and the search system returns relevant documents (i.e., search results) with respect to the queries.

Typical search results are ranked only by quantitative factors. That is, the search engines rank the search results based upon objective or easily quantifiable properties (e.g., number of times the search term appears in the document, and/or number of other web pages that link to the document). Ranking based solely on quantitative factors does not always produce optimal search results. Furthermore, displaying results based solely on quantitative factors does not always produce optimal search results for the user.

Accordingly, a need or potential for benefit exists for a method or system that uses both quantitative and qualitative factors to determine the best search results for a user query, and that improves the quantity and organization of search results.

### BRIEF DESCRIPTION OF THE DRAWINGS

To facilitate further description of the embodiments, the following drawings are provided in which:

FIG. 1 illustrates a box diagram of a computer system configured to generate search results according to a first embodiment;

FIG. 2 illustrates a flow chart for a method of generating search results according to the first embodiment;

FIG. 3 illustrates an exemplary interface, according to the first embodiment;

FIG. 4 illustrates a flow chart for an example of an activity of determining a classification of the potential search results, according to the first embodiment;

FIG. 5 illustrates an example of a sample mark-up for a sentence, according to an embodiment;

FIG. 6 illustrates an example of a word frequency table of a sample source, according to an embodiment;

FIG. 7 illustrates a flow chart for an example of an activity of communicating the search results to the user, according to the first embodiment;

FIG. 8 illustrates an exemplary search results page, according to an embodiment;

FIG. 9 illustrates a computer that is suitable for implementing an embodiment of computer system of FIG. 1;

FIG. 10 illustrates a representative block diagram of an example of the elements included in the circuit boards inside chassis of the computer of FIG. 9;

FIG. 11 illustrates a box diagram of a computer system configured to generate search results according to another embodiment;

FIG. 12 illustrates a flow chart for a method of generating search results according to the embodiment of FIG. 11;

FIG. 13 illustrates a flow chart for a method of communicating the search results to the user, according to another embodiment;

FIG. 14 illustrates an exemplary search results page, according to an embodiment;

FIG. 15 illustrates an exemplary interface, according to the embodiment of FIG. 11; and

FIG. 16 illustrates a flow chart for a method of providing two or more search results, according to another embodiment.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements may be electrically coupled but not be mechanically or otherwise coupled; two or more mechanical elements may be mechanically coupled, but not be electrically or otherwise coupled; two or more electrical elements may be mechanically coupled, but not be electrically or otherwise coupled. Coupling may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

The absence of the word “removably,” “removable,” and the like near the word “coupled,” and the like does not mean that the coupling, etc. in question is or is not removable.

### DESCRIPTION OF EXAMPLES OF EMBODIMENTS

Some embodiments concern a method for organizing two or more search results. The method includes: receiving at least one search parameter from a user; using at least one computer processor to determine a search type based upon the at least one search parameter; using the at least one computer processor to determine potential search results based upon the at least one search parameter; using the at least one computer processor to determine one or more qualitative traits of the potential search results; using the at least one computer processor to organize the two or more search results based upon the search type and the one or more qualitative traits of the potential search results; and displaying the two or more search results to the user.

Various embodiments concern a system configured to generate search results from three or more sources based upon one or more trigger words received from a user. The system generates the search results using at least one computer processor. The system can include: a communications module configured to be executed using the at least one computer processor and further configured to receive the one or more trigger words from the user and to communicate the search results to the user; a preliminary results module configured to be executed using the at least one computer processor and further configured to determine potential search results based upon the one or more trigger words, the potential search results comprises at least two potential sources from the three or more sources; an analysis module to determine a search type based upon the one or more trigger words; a classification module configured to classify the potential search results into two or more predetermined qualitative categories based on a content of the at least two potential sources; a mix module configured to determine an editorial mix of the search results based upon the search type and the potential search results, the editorial mix comprises two or more types of sources; a scoring module configured to determine a score for each source in the potential search results at least partially based upon the editorial mix of the search results; and a results determining module configured to create the search results at least partially based upon the potential search results, the editorial mix of the search results, and the score for each source in the potential search results.

Many embodiments can concern a method for displaying information to a user based upon one or more trigger words. The method can include: receiving the one or more trigger words from the user; using at least one computer processor to determine a search type based upon the one or more trigger words; using the at least one computer processor to determine an editorial mix based upon the search type, the editorial mix comprises two or more types of sources; using the at least one computer processor to determine potential search results based upon the one or more trigger words, the potential search results comprise at least two potential sources; using the at least one computer processor to determine one or more classifications of the potential search results into two or more qualitative categories based on a content of the potential search results; using the at least one computer processor to determine scores for the at least two potential sources at least partially based upon the editorial mix; using the at least one computer processor to determine search results at least partially based upon the potential search results, the editorial mix, and the scores for the at least two potential sources; and communicating the search results to the user.

Various embodiments include a method for providing two or more search results. The method can be implemented via execution of computer instructions configured to run at one or more processing modules and configured to be stored at one or more non-transitory memory storage modules. The method can include receiving at least one search parameter from a search query of a first user. The method also can include determining potential search results based upon the at least one search parameter. The method further can include determining one or more related searches from one or more second users. The method also can include determining two or more search results at least partially based upon the at least one search parameter and the one or more related searches. The method additionally can include determining that the two or more search results are related to a topic. The method further can include organizing the two or more search results based upon the topic. The method also can include displaying the two or more search results to the first user.

A number of embodiments include a method for providing two or more search results. The method can be implemented via execution of computer instructions configured to run at one or more processing modules and configured to be stored at one or more non-transitory memory storage modules. The method can include receiving one or more trigger words from a first user. The method also can include determining potential search results based upon the one or more trigger words. The method further can include determining one or more related searches from one or more second users. The method additionally can include determining environmental information related to the one or more trigger words. The method also can include determining two or more search results at least partially based upon the one or more trigger words, the one or more related searches, and the environmental information. The method further can include communicating the two or more search results to the first user.

Some embodiments include a system configured to generate search results from three or more sources based upon one or more trigger words received from a first user. The system can include one or more processing modules and one or more non-transitory memory storage modules storing computing modules configured to run on the one or more processing modules. The computing modules can include a communications module configured to receive the one or more trigger words from the first user and to communicate the search results to the first user. The computing modules also can include a related search module configured to determine one or more related searches from one or more second users. The computing modules further can include a results module configured to determine the search results based upon the one or more trigger words and the one or more related searches. The search results can include at least two sources from the three or more sources. The computing modules additional can include a topical module configured to determine that the two or more search results are related to a topic. The computing modules also can include an organization module configured to organize the two or more search results based on the topic. The computing modules further can include a display module configured to display the two or more search results to the first user.

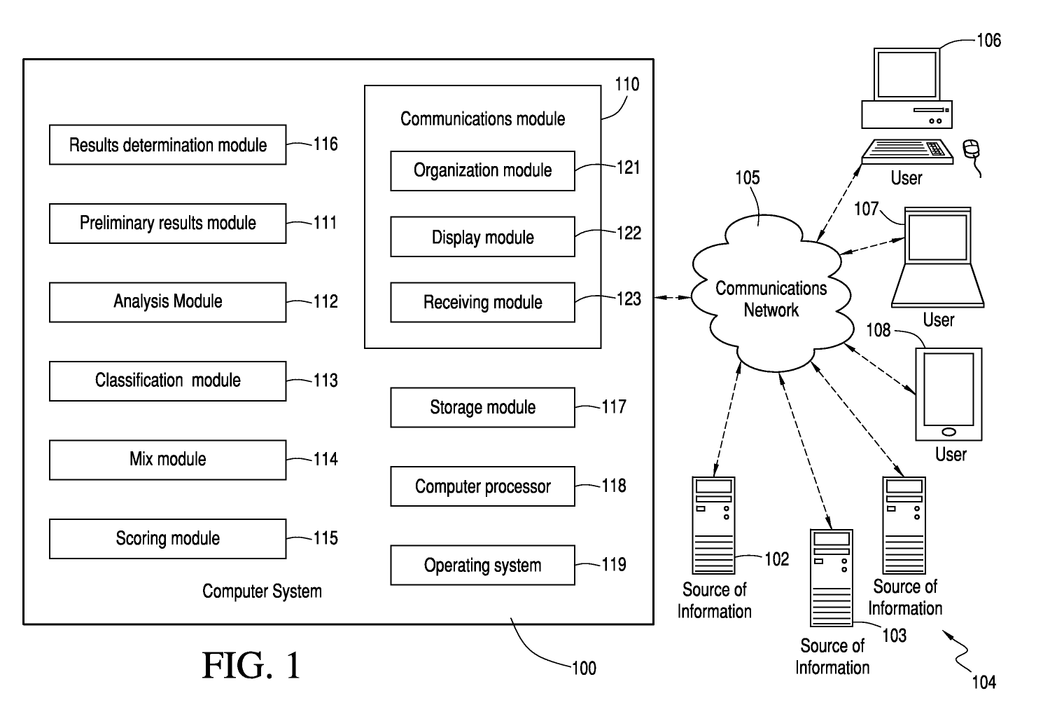

Turning to the drawings, FIG. 1 illustrates a box diagram of a computer system 100 configured to generate search results from three or more sources based upon one or more trigger words, according to a first embodiment. In some examples, computer system 100 can also be considered a computer system for editorializing search results using qualitative traits of the content of the search results or a system for displaying information to a user based upon one or more trigger words. Computer system 100 also can be considered a system for efficient qualitative scoring of text or textually tagged content in various examples or a system for organizing search results. Computer system 100 is merely exemplary and is not limited to the embodiments presented herein. Computer system 100 can be employed in many different embodiments or examples not specifically depicted or described herein.

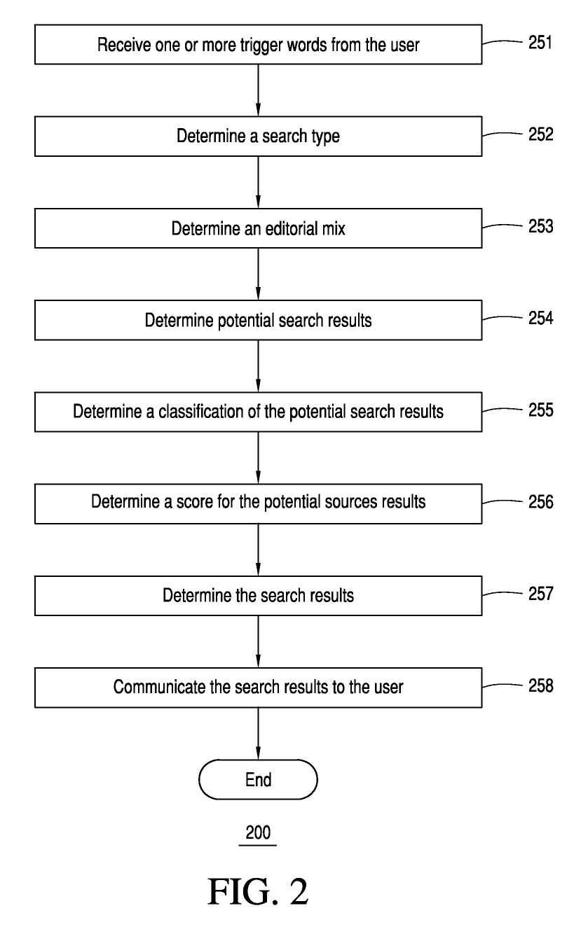

Not to be taken in a limiting sense, a simple example of the usage of computer system 100 and method 200 (FIG. 2) can involve a user searching for a review of a new car. In this example, the user is searching for an imaginary model of “Pygmy” manufactured by an imaginary manufacturer “Romerts.”

When the user searches for “Romerts Pygmy Review” in a search window on a website, computer system 100 identifies that this search is a “comparison search” and determines an editorial mix and search results based on that type of search. In this example, system 100 returns to the user search results that include the manufacture's site as the top result (especially if the manufacturer's website has a page that links to reviews), an “Encyclopedic” result (e.g., a reference that expresses primarily quantitative information about the topic), two journalistic reviews of the topic (e.g., similar to the type of content found in Consumer Reports that expresses opinion, but it is based on facts, and provided by an expert), and a rant liking and a rant disliking the Romerts Pygmy car.

Referring to FIG. 1, in some embodiments, computer system 100 can be configured to receive search parameters or terms (i.e., trigger words) from users 106, 107, and/or 108, and search the information (e.g., web pages, documents, databases, etc.) stored by sources 102, 103, and/or 104.

In some examples, computer system 100 (e.g., a search engine, etc.) can include: (a) a communications module 110 configured to receive trigger words from user 106, 107, and/or 108 and to communicate the search results to the user; (b) a preliminary results module 111 configured to determine potential search results based upon the trigger words; (c) an analysis module 112 to determine a search type based upon the trigger words; (d) a classification module 113 configured to classify the potential search results; (e) a mix module 114 configured to determine an editorial mix of the search results based upon the search type and the potential search results; (f) a scoring module 115 configured to determine a score for each source in the potential search results at least partially based upon the editorial mix of the search results; (g) a results determining module 116 configured to create the search results at least partially based upon the potential search results; (h) a storage module 117; (i) a computer processor 118; and (j) an operating system 119.

Communications module 110 can include: (a) an organization module 121; (b) display module 122; and (c) receiving module 123. Organization module 121 can be configured to organize the search results based upon the classification of the potential search results. Organization module 121 can be further configured to determine the information to display to the user (e.g., user 106, etc.) from a first source (e.g., source 102, etc.), where the first source has a particular classification.

Display module 122 can be configured to visually display information from or about the search results to the user (e.g., user 106, etc.) on a web page or other display mechanism. Receiving module 123 can be configured to receive the search parameters (i.e., trigger words) from users 106, 107, and/or 108.

In various embodiments, classification module 113 can be configured to classify the potential search results into two or more predetermined qualitative categories based on the content of the information of at least one of sources 102, 103, or 104. In some examples, the two or more predetermined qualitative categories or classifications can include writing style, point-of-view of the author, timeframe (e.g., past, recent, present, future, etc.), the level of formality of the content, whether the content is written from instructive purposes (e.g., “How To” work or instructions, etc.), and whether the content is a critique or a review. For example, classification module 113 can be configured to determine a writing style and/or a point-of-view of each potential search result.

Classification module 113 can be further configured to determine the classification by: (a) creating a meta-document based upon the content of a first source (e.g., source 102, etc.); (b) determining a frequency and parts-of-speech (e.g., nouns, verbs, adjectives, adverbs, etc.) of each word in the meta-document; and (c) determining the classification of source 102 using the frequency and the parts-of-speech of each word in the meta-document.

Communications network 105 can be a combination of public and/or private computer networks. For example, communications network 108 can include one or more of the Internet, an Intranet, local wireless or wired computer networks (e.g. a 4G (fourth generation) cellular network, etc.), wide area network (WAN), local area network (LAN), cellular telephone networks, or the like. In many embodiments, computer system 100 communicates with users 106, 107, and 108 and sources 102, 103, and 104 using communications network 105.

“Computer system 100,” as used herein, can refer to a single computing device such as a computer or a server, and “computer system 100” also can refer to a cluster or collection of computers or servers. Typically, a cluster or collection of servers can be used when the demands by client computers (e.g., users 106, 107, and 108, etc.) are beyond the reasonable capability of a single server or computer. In many embodiments, the servers in the cluster or collection of servers are interchangeable from the perspective of the client computers.

In some examples, a single server can include communications module 110, preliminary results module 111, analysis module 112, classification module 113, mix module 114, scoring module 115, and results determining module 116. In other examples, a first server can include a first portion of these modules. One or more second servers can include a second, possibly overlapping, portion of these modules. In these examples, computer system 100 can comprise the combination of the first server and the one or more second servers.

In some examples, storage module 117 can include information or indexes used by computer system 100. The information can be stored on a structured collection of records or data, for instance, which is stored in storage module 117. For example, the indexes stored in storage module 117 can be an XML (Extensible Markup Language) database, MySQL, or an Oracle® database. In the same or different embodiments, the indexes could consist of a searchable group of individual data files stored in storage module 117.

In various embodiments, operating system 119 can be a software program that manages the hardware and software resources of a computer and/or a computer network. Operating system 119 performs basic tasks such as, for example, controlling and allocating memory, prioritizing the processing of instructions, controlling input and output devices, facilitating networking, and managing files. Examples of common operating systems for a computer include Microsoft® Windows, Mac® operating system (OS), UNIX® OS, and Linux® OS.

As used herein, “computer processor” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions.

FIG. 2 illustrates a flow chart of a method 200 of generating search results from three or more sources (e.g., source 102, 103, and 104 (FIG. 1), etc.) based upon one or more trigger words, according to the first embodiment. In some examples, method 200 also can be considered a method to editorialize results using qualitative traits of the content of search results or a method for displaying information to a user based upon one or more trigger words. Method 200 also can be considered a method for qualitatively scoring text or textually tagged content or a method of organizing search results.

Method 200 is merely exemplary and is not limited to the embodiments presented herein. Method 200 can be employed in many different embodiments or examples not specifically depicted or described herein. In some embodiments, the activities, the procedures, and/or the processes of method 200 can be performed in the order presented. In other embodiments, the activities, the procedures, and/or the processes of method 200 can be performed in any other suitable order. In still other embodiments, one or more of the activities, the procedures, and/or the processes in method 200 can be combined or skipped.

Referring to FIG. 2, method 200 includes an activity 251 of receiving one or more trigger words (e.g., “Romerts Pygmy Review”, etc.) from the user. Referring back to FIG. 1, in some examples, one of users 106, 107, or 108 can use a computing device to enter and/or transmit the trigger words to computer system 100. In many examples, the trigger words are transmitted to computer system 100 from user 106, 107, or 108 over communications network 105 (i.e., the Internet or another computer network).

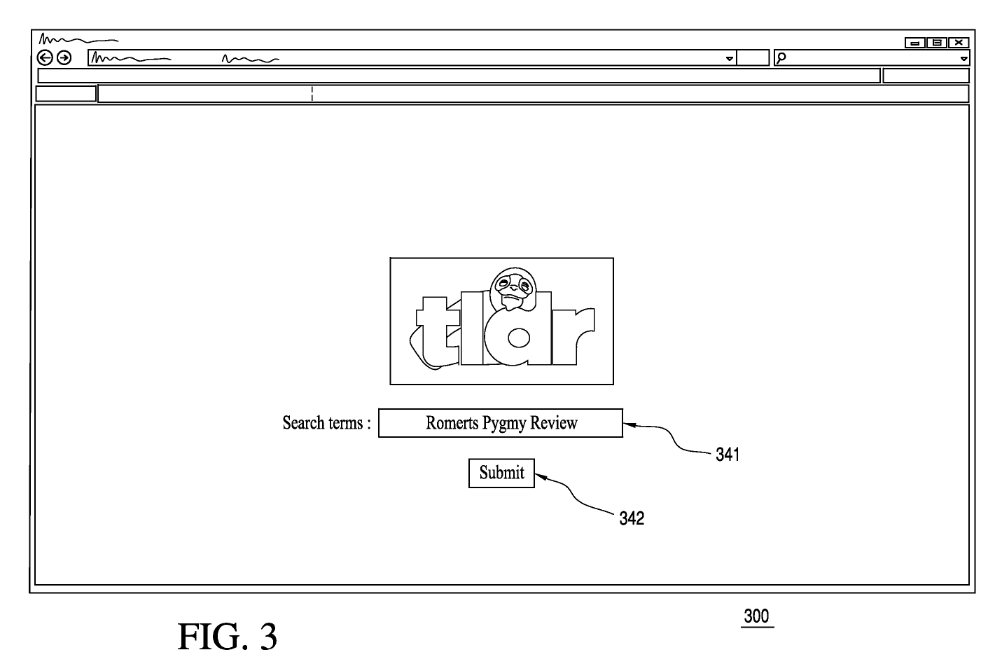

In various embodiments, computer system 100 can generate and/or display one or more web pages and/or other interfaces that user 106, 107, or 108 can use to submit or send the one or more to computer system 100. For example, FIG. 3 illustrates an exemplary interface 300 where the trigger words can be entered by a user, according to the first embodiment. In the example of FIG. 3, one of users 106, 107, or 108 (FIG. 1) can enter the trigger word(s) (e.g., “Romerts Pygmy Review”, etc.) into a text box 341 on interface 300 (e.g., a web page, etc.). When the user clicks submit button 342, the user's computing device can transmit the trigger words to receiving module 123 (FIG. 1) via communications network 105 (FIG. 1).

Referring back to FIG. 2, method 200 in FIG. 2 continues with an activity 252 of determining a search type. In some examples, activity 252 can include using at least one computer processor to determining a search type. In various examples, analysis module 112 (FIG. 1) can determine the search type. The search type is used to determine the mix of information to display to the user as part of the search results. Depending on the type of search, computer system 100 (FIG. 1) can display different mixes and orders of search results.

In some examples, activity 252 can include using at least one computer processor to determine a search type based upon the trigger words. In many embodiments, analysis module 112 (FIG. 1) can determine the search type based upon the one or more trigger words. In many embodiments, analysis module 112 (FIG. 1) can identify the search type based on the meaning of the one or more trigger words. For example, if the trigger words were “Romerts Pygmy review,” analysis module 112 (FIG. 1) can determine that the user is performing a comparison-type search. In another example, if the trigger word is only “Romerts,” analysis module 112 (FIG. 1) could determine that the user is performing an informational-type search. In still another example, if the trigger words include “Romerts Pygmy horse power,” analysis module 112 (FIG. 1) could determine that the user is performing a statistics-type search. In still another example, if the trigger words include “Romerts Pygmy recall,” analysis module 112 (FIG. 1) could determine that the user is performing a government notice-type search. In still other examples, if the trigger words include “How To Fix a Romerts Pygmy . . . ” or “Instructions to repair a Romerts Pygmy,” analysis module 112 (FIG. 1) could determine that the user is performing an instructive-type search.

Subsequently, method 200 of FIG. 2 includes an activity 253 of determining an editorial mix. In some examples, activity 253 can include using at least one computer processor to determine an editorial mix based upon the search type. In some examples, analysis module 112 (FIG. 1) can determine the editorial mix. In various embodiments, the editorial mix for search-types (comparison-type searches, informational-type searches, statistics-type searches, notice-type searches, etc.) can be stored in a database of storage module 117 (FIG. 1). The editorial mix can be a parameter set by an administrator of computer system 100 (FIG. 1) or can be derived or evolve over time based upon a machine learning algorithm based on the type of results to which a user responds (e.g., the type of search results that the user clicks on a search results web page that can be customized to the user by user account, internet protocol (IP) address, device, identification, etc.).

The editorial mix can be a list or group of two or more types of sources or references (e.g., web pages, etc.) that will be shown to the user as the search results. For example, for comparison-type searches, the editorial mix can include the manufacturer's web page(s), an “Encyclopedic” reference (i.e., a reference that expresses primarily quantitative information about the search product), two or more journalistic review of the product (e.g., references that express an opinion but based on facts and provided by an expert, etc.), and at least one favorable rant (i.e., a positive product review, etc.), and at least one unfavorable rant (i.e., a negative review of the product, etc.). These rants can be non-journalist, non-expert user reviews of the product or service.

In another example, the editorial mix for informational-type search can include trusted source(s) written at the high school reading level, trusted sources written at the 6th grade reading level, encyclopedia-type sources (e.g., an online encyclopedia or dictionary, a Wiki), and other non-trusted sources with related information. In still another example, the editorial mix for statistics-type search can include trusted source(s) that includes the statistic (e.g., source from a .gov domain, the website of a manufacturer of the producer, online academic journals, etc.), trusted new sources (e.g., Reuters news service, Associated Press news service, Arizona Republic newspaper website, etc.), other news source that includes the statistic (e.g., blogs, etc.), and sources that have a different number for the same statistic. The different numbers for the same statistic could be because the sources are possibly dated differently or reported from different sources.

In these examples, a trusted source can be a source that has proven creditability. In one example, a list of trusted sources can be stored in storage module 117 (FIG. 1). In some examples, an administrator of computer system 100 (FIG. 1) can enter the list of trusted sources into computer system 100. In the same or different example, computer system 100 can determine if a source is trusted based on a number of factors (e.g., domain type (i.e., .edu, .gov, etc.), links from other trusted sources, number of incoming links, context of links to source on other web pages).

Next, method 200 of FIG. 2 includes an activity 254 of determining potential or preliminary search results. In some examples, activity 254 can include using the at least one computer processor to determine potential search results based upon the one or more trigger words. In various embodiments, preliminary results module 111 (FIG. 1) can determine potential search results based upon the one or more trigger words.

In some examples, preliminary results module 111 (FIG. 1) can use the trigger words ranked by quantitative scoring. That is, preliminary results module 111 (FIG. 1) can rank the search results based upon objective or easily quantifiable properties (e.g., number of times the search term appears in the document, number of other web pages that link to the document, etc.). In many examples, preliminary results module 111 (FIG. 1) can create potential search results that include at least two potential sources (e.g., source 102 and 103 (FIG. 1), etc.). In various examples, preliminary results module 111 (FIG. 1) can assign a preliminary score to each of the potential search results based upon its relevance to the search.

In other examples, preliminary results module 111 (FIG. 1) can use other methods to determine the preliminary search results. For example, preliminary results module 111 (FIG. 1) can use the editorial mix for a specific search to search for results that fit into the specific categories of the editorial mix.

Method 200 in FIG. 2 continues with an activity 255 of determining a classification of the potential search results. In some examples, activity 255 can include using the at least one computer processor to sort, arrange, or otherwise determine a classification of the potential search results into two or more qualitative categories based on the content of the potential sources. In some examples, classification module 113 (FIG. 1) can classify the potential search results.

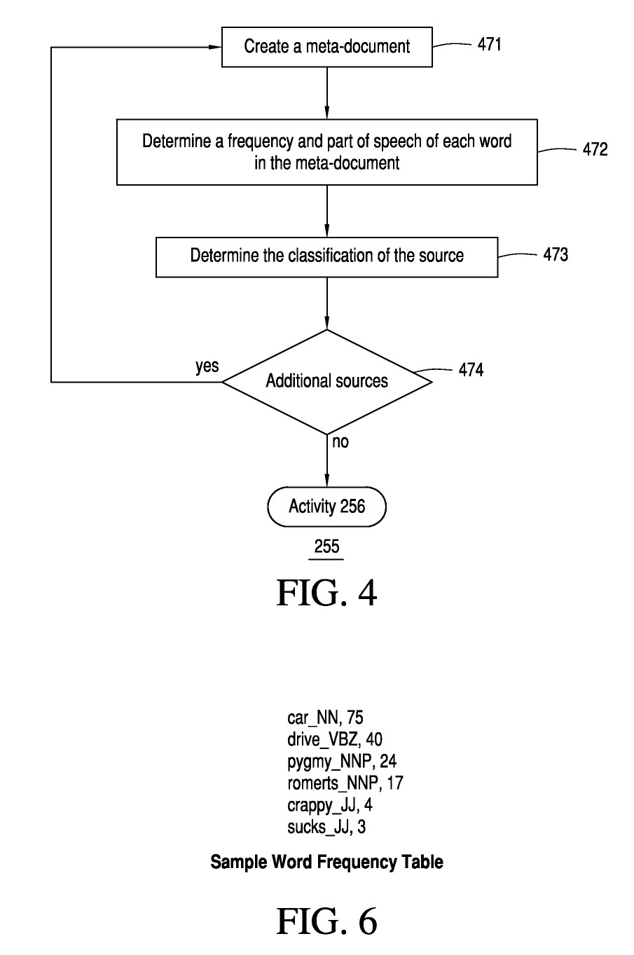

In various examples, classification module 113 (FIG. 1) can classify into two or more qualitative categories or classifications such as writing style (e.g., encyclopedic, journalistic, rant, etc.), point-of-view (e.g., for, against, neutral, etc.), bias (e.g., pro-republican, anti-republican, pro-democrat, anti-democrat, etc.), intent, sentiment, and other qualitative traits. When writing, the intent of the author typically dictates the vocabulary used. While different audiences and subjects change this approach slightly, classifying a type of source can be handled efficiently using a dictionary and comparing the word usage in a source against the dictionary. FIG. 4 illustrates a flow chart for an exemplary embodiment of activity 255 of determining a classification of the potential search results, according to the first embodiment.

Referring to FIG. 4, activity 255 includes a procedure 471 of creating a meta-document (e.g., a mark-up, etc.) for a source in the potential search results. In some examples, procedure 471 can include creating a meta-document based upon the content of a source (e.g., source 102, 103, or 104 (FIG. 1), etc.). Most existing context classification systems use stop words and ignore adjectives. However, for the purpose of classifying a document in terms of its writing style, intent, bias, sentiment, and other qualitative traits, it is useful to identify how adjectives are used.

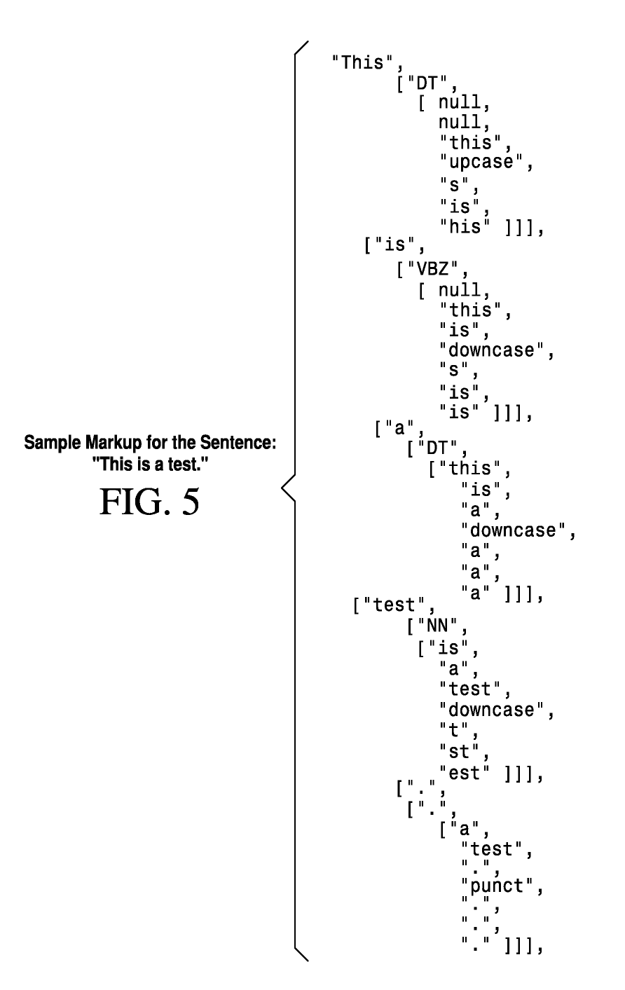

Identifying and classifying adjectives can be typically very computationally intense. To reduce the computation requirements, classification module 113 (FIG. 1) can reduce sources to meta-documents. In many examples, classification module 113 (FIG. 1) can use a natural language analyzer to automatically generate the meta-document in real time. FIG. 5 illustrates an example of a sample mark-up for the sentence “This is a test” using a natural language analyzer. In this example, a Penn Tree method is applied to create the mark-up, but any sufficiently advanced natural language markup can be used instead. In the example mark-up shown in FIG. 5, the mark-up is arranged for each word or punctuation in the sentence as follows: the word, parts-of-speech (e.g., using the Penn parts-of-speech tags where “DT” stands for Determiner, “VBZ” stands for third person singular present verb, “NN” stands for a singular or mass noun), previous word, previous word, lowercase version of word (for efficient matching), original case (e.g., uppercase or lowercase/downcase), last letter/suffix, last two letter suffix, and last three letter suffix.

Classification module 113 (FIG. 1) can apply a natural language mark-up method (e.g., the Penn Tree method) to create a mark-up for the complete source (i.e., the whole document). In other examples, classification module 113 (FIG. 1) can use other methods or procedures to mark-up and/or create a meta-document for the source.

In some examples, as part of creating the mark-up for the source, classification module 113 can be configured to not include quotations from the source in the meta-document. When determining if a source has a positive or negative sentiment about a subject, separation of quotes from the author's sentiment can be useful to ensure accurate results. In some examples, classification module 113 (FIG. 1) can use natural language processing to first identify the portions of text that are quotes, and then remove them from the classification results to help to differentiate the speaker's sentiment from the author's sentiment.

For example, a source might say “According to a speech given by imaginary politician Bob Falseteller, ‘The Elbonian government is entirely made up of thieves and commies.’ This lead to outrage by the Elbonian people.” The sentiment of the author of this source is neutral. The sentiment of Bob Falseteller, who is quoted in the source, is highly negative towards the Elbionian government. When classifying this content (in procedure 473 (FIG. 4) below), the source could be classified as “encyclopedic” or “journalistic,” despite the quote which is more rant-like in nature. If the quoted text were included in the mark-up, this source could possibly be misclassified as a “rant.”

In the same or different examples, classification module 113 (FIG. 1) can separate and store the quotations. In the context of searching for “encyclopedic” or “journalistic” sources, rarely does the searcher care what a journalist said. Instead, the searcher is usually more interested in what the person, who the journalist is reporting about, said. Separating the writings of an author and the quotes from the person being quoted by the author allows for the ability to find relevant information from an authoritative source.

In some examples, classification module 113 (FIG. 1) can use natural language processing to first identify the portions of text that are quotes, index them, and store the quotes differentially (e.g., separately) from the body of the content in storage device 117 (FIG. 1). This differentiation and storage allows for quote-only searching, or searching of quotes by specific individuals.

Activity 255 in FIG. 4 continues with a procedure 472 of determining a frequency and parts-of-speech of each word in the meta-document. In some examples, classification module 113 (FIG. 1) can analyze the meta-document to determine the frequency of each word in the source and the parts-of-speech of each word in the source.

FIG. 6 illustrates an example of a word frequency table of a sample source, according to an embodiment. In the example shown in FIG. 6, the words are sorted by word and parts-of-speech (e.g., using the Penn parts-of-speech tags where “NNP” stands for singular proper noun, “VBZ” stands for third person singular present verb, “NN” stands for a singular or mass noun, and “JJ” stands for an adjective).

Referring back to FIG. 4, activity 255 of FIG. 4 continues with a procedure 473 of determining the classification of the source. In some examples, procedure 473 can include determining the classification of the source using the frequency and the parts-of-speech of each word in the meta-document.

In various examples, classification module 113 (FIG. 1) can use various predetermined rubrics to determine how to classify a document based upon the words and the parts-of-speech of each word. For example, classification module 113 (FIG. 1) can identify the source of the word frequency table in FIG. 6 as a rant (e.g., a non-journalist, non-expert opinion writing). Classification module 113 (FIG. 1) also can identify this source as a rant based upon the multiple uses of the adjectives “crappy” and “sucks.” That is, classification module 113 (FIG. 1) can apply a predetermined weight to each of those words for determining if this source meets the definition of a rant, without having to parse the entire source. On the other hand, classification module 113 (FIG. 1) could look at the nouns and verbs in the source to determine this source is about computers and computation.

By storing parts-of-speech and frequency along with the keyword data, not only is efficiency greatly increased, but accuracy is increased as well. For example, the sentence “I don't want to truck this gravel to Nevada.” uses “truck” as a verb, not the more common usage as a noun. This usage greatly changes the way classification module 113 (FIG. 1) determines if this source is a piece of content about vehicles, or about shipping, as a vehicle classifier might give the noun truck a larger score than the verb truck if the parts-of-speech were unknown.

Next, activity 255 of FIG. 4 includes a procedure 474 of determining whether any additional sources need to be classified. If additional sources need classification, the next procedure in activity 255 is procedure 471. If no additional sources need classification, activity 255 is complete, and the next activity is an activity 256 (FIG. 2).

Referring again to FIG. 2, method 200 of FIG. 2 includes activity 256 of determining a score for the potential sources results. In some examples, activity 256 can include using a computer processor to determine a score for the potential search results at least partially based upon the editorial mix of the potential search results. In some examples, scoring module 115 (FIG. 1) can assign the score to the potential search results based upon the editorial mix and the classification of the potential search results.

For example, scoring module 115 (FIG. 1) can sort the potential search results by type and then apply bonus points to each of the sources in the potential search results based on the editorial mix for the search. In the example of a search for “Romerts Pygmy Review” where the search type was a comparison-type search, the bonus points could be manufacturer: +1000 points, encyclopedic: +500 points, journalistic review: +400 points, positive rant: +300 points, and negative rant: +300 points.

In another example, scoring module 115 (FIG. 1) can apply bonus points to a source if that source links a relevant asset based on the search type. For searches that are detected as document searches (e.g., search for PDF (portable document format) or non-HTML (hypertext markup language) files, etc.) or that are detected that the best answer is likely contained in a PDF or other non-HTML document or file, a bonus is awarded to the source that links to the non-HTML document or file. Scoring module 115 (FIG. 1) also can apply bonus point to a source where the ideal result is a non-text item that does not “display” in a browser (e.g., executable files or archive/compressed files, etc.). That is, executable files (e.g., .exe files, etc.) and archive/compressed files (e.g., Zip and DMG, etc.) cannot be rendered in a browser, but are often what the user is searching for (e.g., search for “download XYZ application”, etc.). Awarding bonuses (e.g., +200 points, etc.) to the source(s) that links to the non-displayable ideal result provides a safer, more user friendly way to present access to the relevant result.

Next, method 200 of FIG. 2 includes an activity 257 of determining the search results. In some examples, activity 257 can include using the at least one computer processor to create the search results at least partially based upon the potential search results, the editorial mix, and the score for the potential sources results. In some examples, mix module 114 (FIG. 1) can create the list of top results based upon the scores for the potential search results.

In some cases a “slot” would be reserved for a specific type of result. A car manufacture or “brand” would likely occupy the top place for a search for that brand, regardless of the authority, popularity, or number of links for that source. A search for something with the word “sucks” might create two slots for negative results and a slot for a positive review, even if the positive review does not include the word “sucks.”

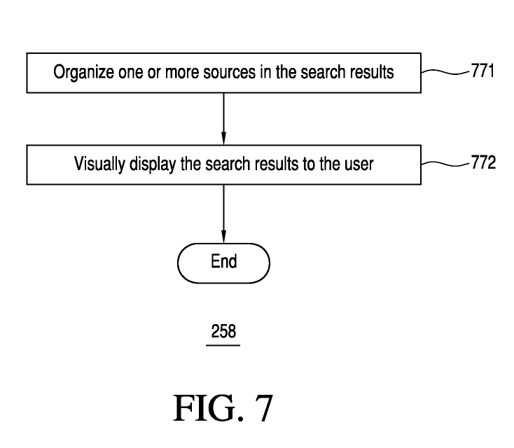

Method 200 in FIG. 2 continues with an activity 258 of communicating the search results to the user. FIG. 7 illustrates a flow chart for an exemplary embodiment of activity 258 of communicating the search results to the user, according to the first embodiment.

Referring to FIG. 7, activity 258 includes a procedure 771 of organizing one or more sources in the search results. In some examples, procedure 771 can include organizing one or more elements of the search results based upon the classification of the potential search results. In many examples, organization module 121 (FIG. 1) can organize the results based upon the editorial mix for the specific search and the score for the potential search results. The search results can include sources within at least two different classifications.

In various embodiments, organization module 121 (FIG. 1) can include the predetermined mix of source types by picking the highest scoring references of each type to fill the available positions in the search results. Additional slots of the search results pages can be filled in by the highest scoring reference, not already included in the search results.

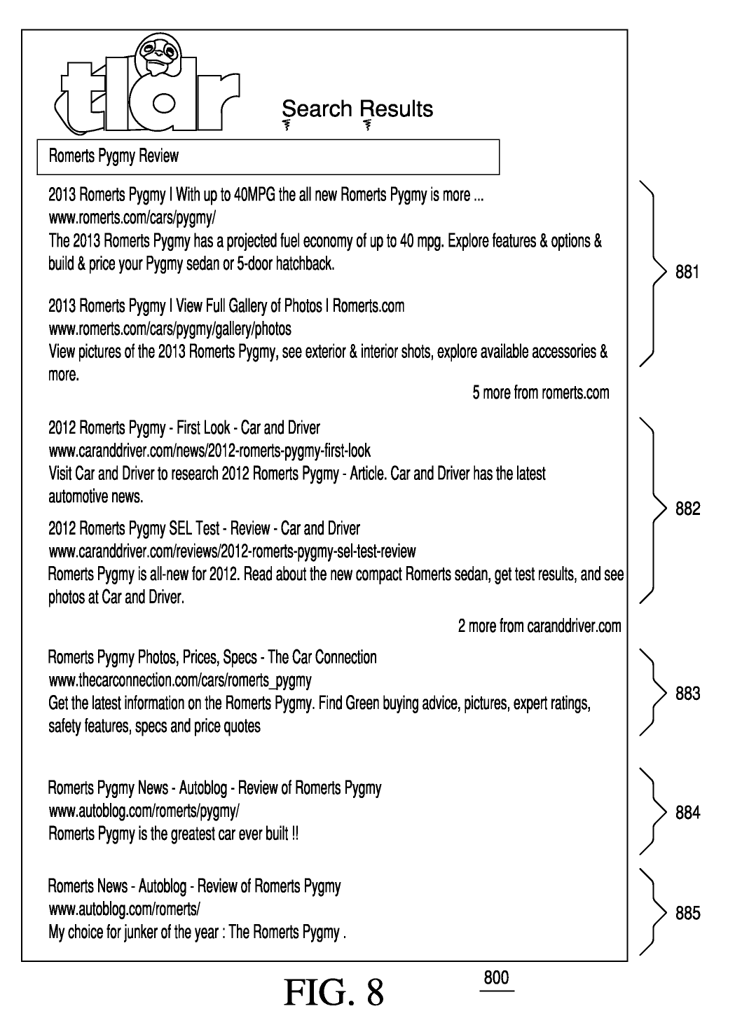

FIG. 8 illustrates an exemplary search results web page 800 for the “Romerts Pygmy Review” search, according to an embodiment. In this example, organization module 121 (FIG. 1) has included two sources 881 from the manufacturer as the top results (one with information about the vehicle and the other with pictures of the vehicle), two journalistic review sources 882, an encyclopedic source 883, a positive rant source 884, and a negative rant source 885.

Activity 258 in FIG. 7 continues with a procedure 772 of displaying the search results to the user. In some examples, procedure 772 can include visually displaying the search results to the user on a web page (e.g., web page 800 of FIG. 8, etc.). In some examples, display module 122 (FIG. 1) can communicate the search results in a predetermined format (e.g., a web page, etc.) to user 106, 107, or 108 (FIG. 1) via communications network 105. In many examples, the search results can be visually displayed by display module 122 (FIG. 1) using a display on a computing device of user 106, 107, or 108 (FIG. 1). After procedure 772, activity 258 and method 200 (FIG. 2) can be complete.

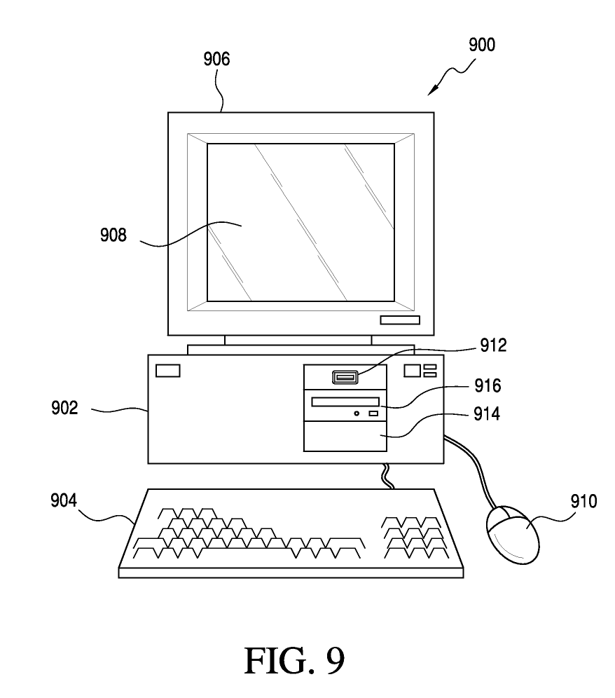

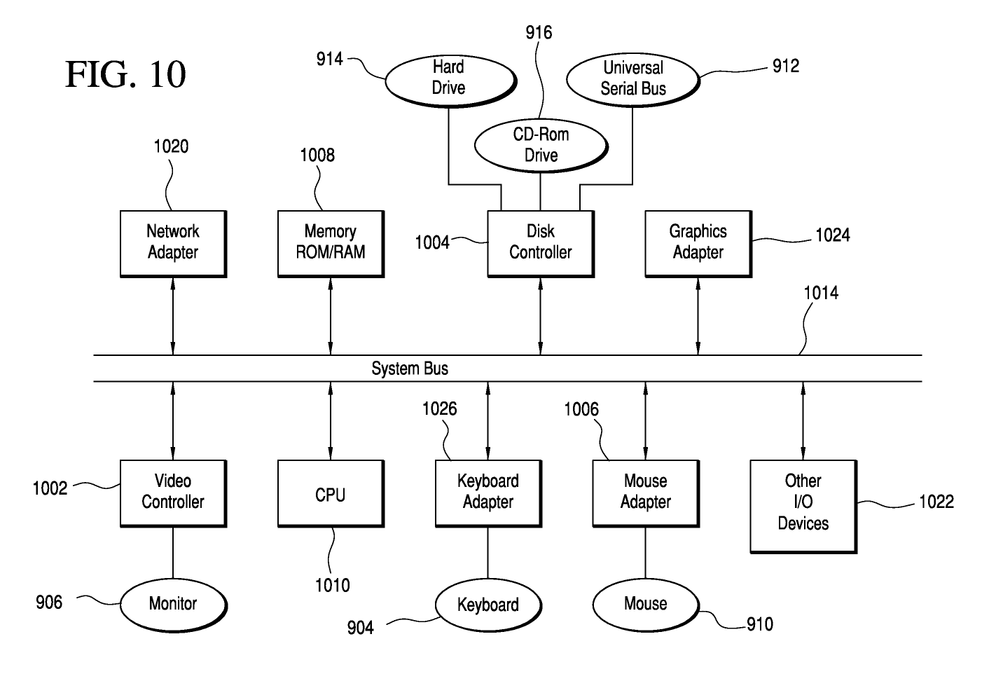

FIG. 9 illustrates a computer 900 that is suitable for implementing an embodiment of at least a portion of computer system 100 (FIG. 1). Computer 900 includes a chassis 902 containing one or more circuit boards (not shown), a USB (universal serial bus) port 912, a Compact Disc Read-Only Memory (CD-ROM) and/or Digital Video Disc (DVD) drive 916, and a hard drive 914. A representative block diagram of the elements included on the circuit boards inside chassis 902 is shown in FIG. 10. A central processing unit (CPU) 1010 in FIG. 10 is coupled to a system bus 1014 in FIG. 10. In various embodiments, the architecture of CPU 1010 can be compliant with any of a variety of commercially distributed architecture families.

System bus 1014 also is coupled to non-volatile memory 1008 that includes both read only memory (ROM) and random access memory (RAM). Non-volatile portions of memory 1008 or the ROM can be encoded with a boot code sequence suitable for restoring computer 900 (FIG. 9) to a functional state after a system reset. In addition, memory 1008 can include microcode such as a Basic Input-Output System (BIOS). In some examples, storage module 117 (FIG. 1) can include a USB drive in USB port 912, on a CD-ROM or DVD in CD-ROM and/or DVD drive 916, hard drive 914, or non-volatile memory 1008.

In the depicted embodiment of FIG. 10, various I/O devices such as a disk controller 1004, a graphics adapter 1024, a video controller 1002, a keyboard adapter 1026, a mouse adapter 1006, a network adapter 1020, and other I/O devices 1022 can be coupled to system bus 1014. Keyboard adapter 1026 and mouse adapter 1006 are coupled to a keyboard 904 (FIGS. 9 and 10) and a mouse 910 (FIGS. 9 and 10), respectively, of computer 900 (FIG. 9). While graphics adapter 1024 and video controller 1002 are indicated as distinct units in FIG. 10, video controller 1002 can be integrated into graphics adapter 1024, or vice versa in other embodiments. Video controller 1002 is suitable for refreshing a monitor 906 (FIGS. 9 and 10) to display images on a screen 908 (FIG. 9) of computer 900 (FIG. 9). Disk controller 1004 can control hard drive 914 (FIGS. 9 and 10), USB port 912 (FIGS. 9 and 10), and CD-ROM or DVD drive 916 (FIGS. 9 and 10). In other embodiments, distinct units can be used to control each of these devices separately.

Network adapters 1020 can be coupled to one or more antennas. In some embodiments, network adapter 1020 is part of a WNIC (wireless network interface controller) card (not shown) plugged or coupled to an expansion port (not shown) in computer 900. In other embodiments, the WNIC card can be a wireless network card built into internal computer 900. A wireless network adapter can be built into internal client computer 900 by having wireless Ethernet capabilities integrated into the motherboard chipset (not shown), or implemented via a dedicated wireless Ethernet chip (not shown), connected through the PCI (peripheral component interconnector) or a PCI express bus. In other embodiments, network adapter 1020 can be a wired network adapter.

Although many other components of computer 900 (FIG. 9) are not shown, such components and their interconnection are well known to those of ordinary skill in the art. Accordingly, further details concerning the construction and composition of computer 900 and the circuit boards inside chassis 902 (FIG. 9) need not be discussed herein.

When computer 900 in FIG. 9 is running, program instructions a USB drive in USB port 912, on a CD-ROM or DVD in CD-ROM and/or DVD drive 916, on hard drive 914, or in non-volatile memory 1008 (FIG. 10) are executed by CPU 1010 (FIG. 10). A portion of the program instructions, stored on these devices, can be suitable for carrying out method 200 (FIG. 2) as described previously with respect to FIGS. 1-8.

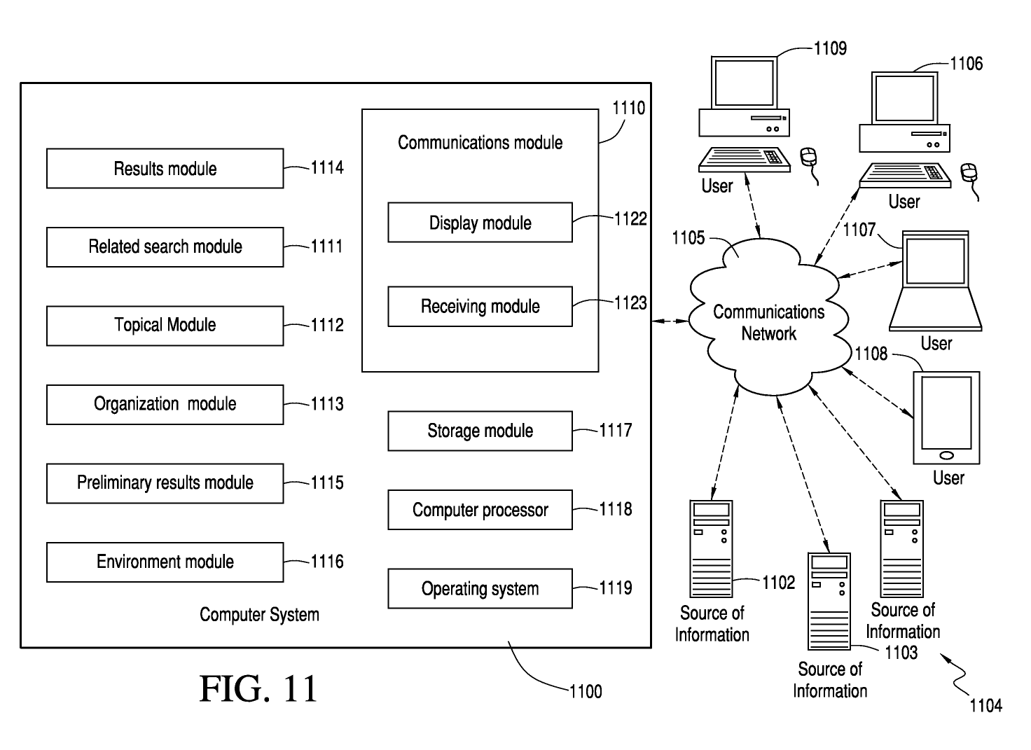

Turning ahead in the drawings, FIG. 11 illustrates a box diagram of a computer system 1100 configured to generate search results from three or more sources based upon one or more trigger words, according to an embodiment. Computer system 1100 can be similar to computer system 100 (FIG. 1), and/or one or more components of computer system 1100 can be identical or similar to one or more components of computer system 100 (FIG. 1). In some examples, computer system 1100 can be considered a computer system for organizing or providing search results or a system for displaying information to a user based upon one or more trigger words. Computer system 1100 is merely exemplary and is not limited to the embodiments presented herein. Computer system 1100 can be employed in many different embodiments or examples not specifically depicted or described herein.

Referring to FIG. 11, in some embodiments, computer system 1100 can be configured to receive search parameters or terms (i.e., trigger words) from users 1106, 1107, 1108, and/or 1109, and search the information (e.g., web pages, documents, databases) stored by sources 1102, 1103, and/or 1104.

In some examples, computer system 1100 (e.g., a search engine) can include: (a) a communications module 1110 configured to receive trigger words from one or more first users 1106 and/or 1107, and to communicate the search results to one or more first users 1106 and/or 1107; (b) a related search module 1111 configured to determine one or more related searches from one or more second users 1108 and/or 1109; (c) a topical module 1112 configured to determine that the search results are related to a topic; (d) an organization module 1113 configured to organize the two or more search results into a discussion format; (e) a results module 1114 configured to determine search results based upon the trigger words, environmental information, and/or one or more related searches; (f) a preliminary results module 1115 configured to determine potential search results based upon the trigger words; (g) an environment module 1116 configured to determine environmental information; (h) a storage module 1117; (i) a computer processor 1118; and/or (j) an operating system 1119.

Communications modules 1100 can be identical or similar to communications module 110 (FIG. 1). Communications module 1110 can include: (a) display module 1122; and (b) receiving module 1123. Display module 1122 can be identical or similar to display module 122 (FIG. 1). Display module 1122 can be configured to visually display information from or about the search results to the user (e.g., user 1106, etc.) on a web page or other display mechanism. Receiving module 1123 can be identical or similar to receiving module 123 (FIG. 1). Receiving module 1123 can be configured to receive the search parameters (i.e., trigger words) from users 1106, 1107, 1108, and/or 1109.

Organization module 1113 can be further configured to determine the information to display to the user (e.g., user 1106, etc.) information from a first source (e.g., source 1102, etc.), where the first source has a particular classification. In other examples, organization module 1113 can be part of communications module 1110.

Communications network 1105 can be identical or similar to communications network 105 (FIG. 1). Communications network 1105 can be a combination of public and/or private computer networks. For example, communications network 1105 can include one or more of the Internet, an Intranet, local wireless or wired computer networks (e.g. a 4G (fourth generation) cellular network, etc.), wide area network (WAN), local area network (LAN), cellular telephone networks, or the like. In many embodiments, computer system 1100 communicates with users 1106, 1107, 1108, and 1109 and sources 1102, 1103, and 1104 using communications network 1105.

“Computer system 1100,” as used herein, can refer to a single computing device such as a computer or server, and “computer system 1100” also can refer to a cluster or collection of computers or servers. Typically, a cluster or collection of servers can be used when the demands by client computers (e.g., users 1106, 1107, 1108, and 1109) are beyond the reasonable capability of a single server or computer. In many embodiments, the servers in the cluster or collection of servers are interchangeable from the perspective of the client computers.

In some examples, a single server can include communications module 1110, related search module 1111, topical module 1112, organization module 1113, results module 1114, preliminary results module 1115, and environment module 1116. In other examples, a first server can include a first portion of these modules. One or more second servers can include a second, possibly overlapping, portion of these modules. In these examples, computer system 1100 can comprise the combination of the first server and the one or more second servers.

In some examples, storage module 1117 can include information or indexes used by computer system 1100. The information can be stored on a structured collection of records or data, for instance, which is stored in storage module 1117. For example, the indexes stored in storage module 1117 can be an XML (Extensible Markup Language) database, a MySQL database, or an Oracle® database. In the same or different embodiments, the indexes could consist of a searchable group of individual data files stored in storage module 1117.

In various embodiments, operating system 1119 can be a software program that manages the hardware and software resources of a computer and/or a computer network. Operating system 1119 performs basic tasks such as, for example, controlling and allocating memory, prioritizing the processing of instructions, controlling input and output devices, facilitating networking, and managing files. Examples of common operating systems for a computer include Microsoft® Windows, Mac® operating system (OS), UNIX® OS, and Linux® OS.

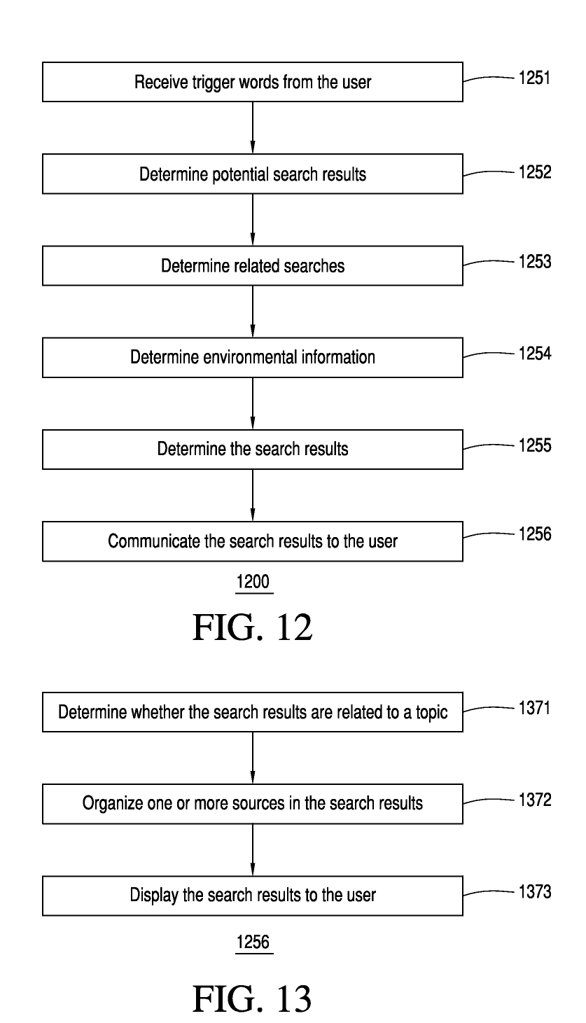

FIG. 12 illustrates a flow chart of a method 1200 of generating search results from three or more sources (e.g., source 1102, 1103, and 1104 (FIG. 11), etc.) based upon one or more trigger words, according to an embodiment. Method 1200 is merely exemplary and is not limited to the embodiments presented herein. Method 1200 can be employed in many different embodiments or examples not specifically depicted or described herein. In some embodiments, the activities, the procedures, and/or the processes of method 1200 can be performed in the order presented. In other embodiments, the activities, the procedures, and/or the processes of method 1200 can be performed in any other suitable order. In still other embodiments, one or more of the activities, the procedures, and/or the processes in method 1200 can be combined or skipped.

In some examples, method 1200 also can be considered a method to editorialize results using qualitative traits of the content of search results or a method for displaying information to a user based upon one or more trigger words. Method 1200 also can be considered a method for qualitatively scoring text or textually tagged content or a method of organizing search results.

In some embodiments, method 1200 can apply a multiple step refinement process or feedback loop to determine search results and the organization of the search results based upon the user's purpose in performing the search results. Using additional information to clarify or better understand the user's purpose (e.g., the user's ideal results from the search, etc.) allows computer system 1100 (FIG. 11) to provide more relevant results than traditional search engines.

As a general, non-limiting example, computer system 1100 (FIG. 11) can first determine preliminary or potential search results based upon the search terms. These search results can be determined by many different conventional methods, such as by ranking search results based upon objective or quantifiable properties, such as the number of times the search term appears in the document, and/or the number of other web pages that link to the document.

Next, computer system 1100 (FIG. 11) can determine related queries or searches of other users to determine a purpose or topic of the user's search. For example, a user inputs the search terms “Soft Kitty,” which is the name of a theme song from a popular television show. Other people have recently performed searches for “Soft Kitty lyrics” and “Soft Kitty MP3” and “Soft Kitty Song.” Based on these recent related searches, computer system 1100 can presume that the user is most likely search for the “Soft Kitty” song, not pictures or information about cats. Using prior search results to refine or enlighten computer system 1100 as to the purpose of the search is not possible with traditional search engines. A traditional search engine would have to consult a database of all songs ever released (if such database even existed and if this song was in the database) to determine that a user was searching for a song title.

Similarly, search parameters starting with “who is” indicates that a search is for a person. If large numbers of people go searching for “who is severus snape” rather than consulting a database of people, computer system 1100 can determine that this is a person search. Combining this information with related searches “severus snape actor,” “severus snape fan fiction” and “severus snape character” from other users tells computer system 1100 that Severus Snape is a fictional character. The necessity for having huge databases and keeping them up to date with a large staff or by purchasing data on an ongoing basis is eliminated by analyzing search trends from various users and applying natural language processing to determine what a “thing” is.

Furthermore, users rarely type all of the words of a search they are looking for because most search engines have a stop words list that ignores many words. For example, “how to make chili” is what a user searching for “make chili” is searching for. Using search trends, computer system 1100 can determine that many of the users who are searching for “make chili” are searching for “how to make chili” and that “make chili” is a subset of the longer search phrase. With this information, computer system 1100 can favor content that is detected as instructional.

The same technique can be used to identify “lord of the rings” as a movie, book, and reference topic because of searches for “lord of the rings books,” “lord of the rings director” and other indicators from the searches of other users. Thus, the system can determine the intent or purpose of the search without having the complete search phrase.

Next, the search results can be further refined and/or the purpose of the search results can be further clarified by using environmental information related to current events or other information about what is trending to even further refine or clarify the search results. For example, a user can type in a search with a common name of a person. Computer system 1100 can use television guide data to determine that a popular show staring an actor with that name just ended on one of the major networks so computer system 1100 can use this environmental factor to bring to the top of the search results web page, information about that actor and the television show, even if that information would not have otherwise been at the top of the search results web page. In another example, computer system 1100 can use information about what is popular, hot, or trending on a social networking site to clarify or refine the purpose of a search.

Additionally, in some examples, the context or qualitative factors can be used to organize the search results in a manner or format that is best suited for the topic or type of search. For example, computer system 1100 can determine that the purpose of a user's search is to find information about a discussion of a topic. Computer system 1100 can organize the search results in a discussion format (e.g., a thread format, etc.) to allow the user to easily follow the discussion of the topic. This discussion of the topic does not have to take place in the comments of an article or in a thread on a single web page, but rather can be spread out over multiple independent web pages. Recognizing that conversations happen between authors on the web not only in the comments, but in actual posts on different websites, computer system 1100 can display content as “threads” even if those threads happen to be a different websites.

For example, a recent newspaper reported on its website about how a Tesla® automobile died during a test drive. The manufacturer of the automobile posted a response to the story on the manufacturer's website, not on the newspaper's website. The newspaper, then, wrote a second article on its website in response to the manufacturer's posting. Finally, several other media sources weighed in on the discussion between the newspaper and the automobile manufacturer. If a user performs a search for, for example, “tesla car controversy,” computer system 1100 can group together the original newspaper story, the manufacturer's response, the second newspaper story, and the other articles about the controversy to show how they relate to each other, and the evolution of the story.

Referring to FIG. 12, method 1200 includes an activity 1251 of receiving one or more trigger words (e.g., “Soft Kitty”, etc.) from the user. Referring back to FIG. 11, in some examples, one or more of users 1106 and/or 1107 can use a computing device to enter and/or transmit the trigger words to computer system 1100. In many examples, the trigger words are transmitted to computer system 1100 from user(s) 1106 and/or 1107 over communications network 1105 (e.g., the Internet, or another computer network, etc.).

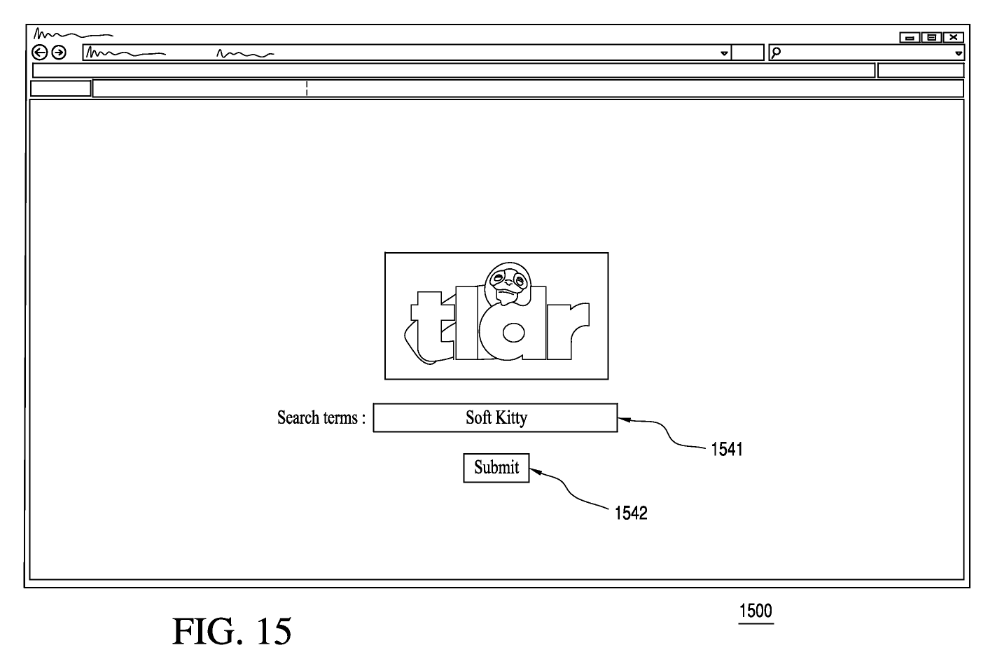

In various embodiments, computer system 1100 can generate and/or display one or more web pages and/or other interfaces that user(s) 1106 and/or 1107 can use to submit or send the one or more to computer system 1100. For example, FIG. 15 illustrates an exemplary interface 1500 where the trigger words can be entered by a user, according to the first embodiment. In the example of FIG. 15, one or more of users 1106 and/or 1107 (FIG. 11) can enter the trigger word(s) (e.g., “Soft Kitty”, etc.) into a text box 1541 on interface 1500 (e.g., a web page, etc.). When the user clicks the submit button 1542, the user's computing device can transmit the trigger words to receiving module 1123 (FIG. 11) via communications network 1105 (FIG. 11).

Next, method 1200 of FIG. 12 includes an activity 1252 of determining potential or preliminary search results. In some examples, activity 1252 can include using the at least one computer processor to determine potential search results based upon the one or more trigger words. In various embodiments, preliminary results module 1115 (FIG. 11) can determine potential search results based upon the one or more trigger words.

In some examples, preliminary results module 1115 (FIG. 11) can use the trigger words ranked by quantitative scoring. That is, preliminary results module 1115 (FIG. 11) can rank the search results based upon objective or easily quantifiable properties (e.g., the number of times the search term appears in the document, the number of other web pages that link to the document, etc.). In many examples, preliminary results module 1115 (FIG. 11) can create potential search results that include at least two potential sources (e.g., source 1102 and 1103 (FIG. 11), etc.). In various examples, preliminary results module 1115 (FIG. 11) can assign a preliminary score to each of the potential search results based upon its relevance to the search. In other examples, preliminary results module 1115 (FIG. 11) can use other methods to determine the preliminary search results.

In a number of embodiments, the preliminary score assigned to each of the potential search results and/or the trigger words provided can be used by preliminary results module 1115 (FIG. 11) to determine a preliminary search type. For example, determining the preliminary search type can be identical or similar to activity 252 (FIG. 2) of determining a search type based upon trigger words. For example, if a user searches for “cupcake recipe,” preliminary results module 1115 (FIG. 11) can determine that searches for a recipe are often a “how to” search type. As such, preliminary results module 1115 (FIG. 11) can determine that the search has a “how to” preliminary search type.

As another example, a user, such as one or more of users 1006 or 1007, can search for “what is the president doing?” Preliminary results module 1115 (FIG. 11) can determine from the trigger words and/or the preliminary score assigned to each of the potential search results that the preliminary search type is a news search type. To determine whether a source is straight news or op-ed news, preliminary results module 1115 (FIG. 11) can analyze words used in the source for opinionated words. For example, describing a car as “small,” is generally objective and not opinion. Describing a car as “puny,” however, is generally an opinion.

As yet another example, a user can search for “what is the Xbox price?” Preliminary results module 1115 (FIG. 11) can determine from the trigger words and/or the preliminary score that the preliminary search type is a shopping search type.

Referring back to FIG. 12, method 1200 in FIG. 12 continues with an activity 1253 of determining related searches. In some examples, activity 1253 can include using the at least one computer processor to determine related searches. In various embodiments, related search module 1111 (FIG. 11) can determine potential search results based upon the one or more trigger words.

In some examples, computer system 1100 (FIG. 11) can store information about recent searches (e.g., search terms) in storage module 1117 (FIG. 11). As an example, the recent searches could have been performed within 1, 2, 3, 5, 10, 30, 60, 90, 120, 180, or 240 minutes, 1 day, or 1 week of the current search. In many examples, natural language comparison algorithms can be used to compare the current search with recent searches. In various examples, related search module 1111 (FIG. 11) can access the information about recent searches and compare the recent search terms to the current search terms to determine to find related searches. In one embodiment, related search module 1111 (FIG. 11) can determine if the current search and any recent searches include one or more of the same trigger words. In the “who is severus snape” example, the current search has the common trigger words “severus snape” with several recent searches. In this case, the searches with trigger words: “severus snape actor,” “severus snap fan fiction” and “severus snape character” would be considered related searches.

As another example, a user can search for “when was the president born?” Preliminary results module 1115 (FIG. 11) could determine in activity 1252 of determining potential search results that, based on the trigger words, “when” and “born,” that the preliminary search type is encyclopedic. Similarly, a user can search for “when was strawberry shortcake born?” In this latter example, preliminary results module 1115 (FIG. 11) could likewise determine in activity 1252 of determining potential search results that, based on the trigger words, “when” and “born,” that the preliminary search type is encyclopedic. In activity 1253 of determining related searches, however, related search module 1111 (FIG. 11) can determine that the common trigger words “strawberry shortcake” are often searched by users looking for fan sites, and by users looking for information on the brand or manufacturer. If preliminary scores for the information-based sites are higher than for fan sites, related search module 1111 (FIG. 11) can determine that instead of being an encyclopedic search type, the search type for “when was strawberry shortcake born?” should rather be a news search type.

In many embodiments, determination of the search type can be based on a score that is based not only the quantitative factors considered in activity 1252 of determining potential or preliminary search results, but is also based on related searches. For example, if a user searches for “cats and dogs,” a quantitative approach can give greater points to sources that include both mentions of both “cats” and “dogs,” than “cat” or “dogs” individually. In many embodiments, sources that have proven creditability or are otherwise determined to be trusted sources, can be assign greater points, as described above in relation to activity 253 (FIG. 2) of determining an editorial mix. For example, sources that are written by an author, have a table of contents, and/or have a social network, can be awarded greater points for having a greater likelihood of being a creditable source. Moreover, sources that include topics that are prevalent in related searches can be awarded greater points, as being more relevant. In many embodiments, determination of prevalence of a topic in related searches can be performed using conventional noun entity extraction and/or noun phrase extraction.

Method 1200 in FIG. 12 continues with an activity 1254 of determining environmental information related to the trigger words. In some examples, activity 1254 can include using the at least one computer processor to determine the environmental information related to the trigger words. In various embodiments, environment module 1116 (FIG. 11) can determine the environmental information.

In various embodiments, environmental information can include information regarding people, places, things, and events that are currently popular or trendy, newsworthy, or otherwise drawing interest of people. In some embodiments, environment module 1116 (FIG. 11) can determine if there is any environmental information that can help determine a purpose of the user's search. For example, many news articles in the last few hours could have been published about a formerly obscure politician name Wendy Smith, and the user does a search for “W. Smith.” Environment module 1116 (FIG. 11) can determine that that this environmental information regarding Wendy Smith may be relevant to the purpose of the user's search. Traditional search engines do not make this connection, and consequently, when a user performs that search for “W. Smith,” the search results would be improperly dominated with information about a famous actor named Will Smith.

In another example, if a movie will be released in a few days, environment module 1116 (FIG. 11) can determine that, if a user is searching for terms that include part of the movie title, the purpose of the search may be to find information about the movie.

In some examples, environment module 1116 (FIG. 11) can find the environmental information by searching commercial databases of information or various websites. The environmental information can include, for example information about movies, television shows, current events, politics, sports, theater, weather, trending or popular people or things, new products or services, and/or upcoming holidays or events.

In a number of embodiments, environment module 1116 (FIG. 11) can factor in the user's location, such as based on Geo-IP (Internet Protocol) address services. For example, if someone located in New York City enters a search that was determined, such as in activities 1252 and/or 1253 to have a search type of news, environment module 1116 (FIG. 11) can provide environment information, which can be used to favor results from news sources primarily serving the New York area.

In various embodiments, environment module 1116 (FIG. 11) can build a profile of the user's preferences and provide environment information as to those preferences. Exemplary preferences can include whether the user is politically right-leaning or left-leaning, the reading level of sources read by the user in the past, whether the user prefers encyclopedic sources over op-ed sources, the length of sources preferred by the user, and other suitable preferences.

In several embodiments, environment module 1116 (FIG. 11) can determine whether the user is using a computer or a mobile device. Many web pages have traditional and/or mobile formats. In various embodiments, environment module 1116 (FIG. 11) can provide environment information regarding the user's device type, which can be used to favor web page articles in formats corresponding the user's device type.

Next, method 1200 of FIG. 12 includes an activity 1255 of determining the search results. In some examples, activity 1255 can include using the at least one computer processor to create the search results at least partially based upon one or more of the potential search results, the related searches information, and/or the environmental information. In some examples, results module 1114 (FIG. 11) can create a list of best results (i.e., the most relevant results for the user's purpose) based upon the scores for the potential search results.

In some examples, results module 1114 (FIG. 11) can use related search information and/or environmental information to determine potential purposes of the search. In the “Soft Kitty” example, results module 1114 (FIG. 11) can determine that the user is searching for the “Soft Kitty” song based on the related recent searches. In the “W. Smith” example, results module 1114 (FIG. 11) can determine the purpose of the search was to information about “Wendy Smith” using environmental information. In addition to determining the purpose of the search, results module 1114 (FIG. 11) also can determine the type of search using the related search information and/or environmental information.

As another example, the type of search can be used to create a list of best results. For example, for a search with a “how to” search type, the list of best results can predominantly include instructional, step-wise, and/or not opinionated sources. For a search with a news search type, the list of best results can predominantly include results that are a mix of straight news and op-ed news. As a further example, for a shopping search type, the list of best results can predominantly include sources for purchasing the product, such as an Xbox, along with the purchase price.

As yet another example, if someone located in New York City enters a search with a news search type, the environmental information can be used with the news search type to favor results from news sources primarily serving the New York City area. As a further example, environment information regarding the user's device type can be used to favor web page articles in formats corresponding the user's device type.

Results module 1114 (FIG. 11) can use the information regarding the purpose or search type to determine the best search results from the potential search results. In some examples, results module 1114 (FIG. 11) can choose potential search results related to the purpose or search type and rate this information as most relevant to the user's search.

Method 1200 in FIG. 12 continues with an activity 1256 of communicating the search results to the user. FIG. 13 illustrates a flow chart for an exemplary embodiment of activity 1256 of communicating the search results to the user, according to the first embodiment.

Referring to FIG. 13, activity 1256 includes a procedure 1371 of determining whether the search is related to a discussion topic. In some examples, topical module 1112 (FIG. 11) can determine if the search results are related to a specific discussion topic. For example, topical module 1112 (FIG. 11) can use the purpose of the search and search type, as determined in activity 1255 of FIG. 12, to determine whether the search is related to a discussion topic. A discussion topic can involve any subject matter. To be a discussion topic, an item should have two or more sources in which the authors of the sources have a conversation about an item. For example, a discussion topic could be a new product if two or more highly scored blogs are discussing the advantages and disadvantages of the new product. In a further example, a discussion topic could be based on back and forth articles about a political topic in two or more news web pages.

As yet another example, Samsung could release a press release regarding a new product. In response, the various authors could write articles about the Samsung press release and the new product. If a user searches for information regarding the newly announced product, topical module 1112 (FIG. 11) can determine that the search is related to the discussion topic of the Samsung press release.

Next, activity 1256 of FIG. 13 continues with a procedure 1372 of organizing one or more sources in the search results. In some examples, procedure 1372 can include organizing one or more elements of the search results based upon the discussion topic. In some examples, organization module 1113 (FIG. 11) can organize the search results in a discussion format. For example, organization module 1113 (FIG. 11) can group the two or more search results based upon a chronological order of the two or more search results in a discussion of the topic. In various examples, the grouping is performed independent of an authoritativeness of the two or more search results.

In some examples, organizing the sources in the search results can include determining an origin of the topic. For a discussion of a topic to take place, there should be an origin of the discussion topic (e.g., a first post on a website or blog about the topic, etc.). In the Tesla example, the origin is the original newspaper article about the test drive.

Next, organizing the sources in the search results can include determining one or more subsequent responses to the origin. In various examples, organization module 1113 (FIG. 11) can determine subsequent responses in the search results to the origin. In the Tesla example, the manufacturer's response, the second new article, and the stories by other media sources are the subsequent responses. In some examples, organization module 1113 (FIG. 11) can determine the chronological order of the subsequent responses.

As another example, if Samsung released a press release regarding a new product, and various authors could wrote articles about the Samsung press release and the new product, including a New York Times article, and various authors wrote articles responding to and/or critiquing the New York Times article, the Samsung press release would be the origin, and all the other articles could be subsequent responses. Organization module 1113 (FIG. 11) can determine the ordering of responses by placing first the origin, followed by the New York Times article, followed by responses/critiques to the New York Times article, followed by other articles about the press release.

In other embodiments, for example when there is no discussion topic, organization module 1113 (FIG. 11) can include the predetermined mix of source types by picking the highest scoring references to fill the available positions in the search results. Additional slots of the search results pages can be filled in by the highest scoring reference, not already included in the search results.

Activity 1256 in FIG. 13 continues with a procedure 1373 of displaying the search results to the user. In some examples, procedure 1373 can include visually displaying the search results to the user on a web page. In some examples, display module 1122 (FIG. 11) can communicate the search results in a predetermined format (e.g., a web page) to one or more of users 1106 and/or 1107 (FIG. 11) via communications network 1105. In many examples, the search results can be visually displayed by display module 1122 (FIG. 11) using a display on a computing device of one or more of users 1106 or 1107.

In some examples, displaying the search results to the user can include displaying the origin of the topic to the user and, after displaying the origin of the topic, displaying the one or more subsequent responses. In some examples, procedure 1373 can include displaying a search results web page to the user with the origin of the topic and one or more subsequent responses, where the origin of the topic is displayed before displaying one or more subsequent responses on the search results web page. In many examples, the order of the two or more results in the discussion format are organized independent of a score for each of the two or more search results.

For the Samsung press release example, display module 1122 (FIG. 11) can order the responses by first displaying the origin at the top of a web page of search results, followed by the New York Times article, followed by responses/critiques to the New York Times article, followed by other articles about the press release.

In some examples, displaying the results in a discussion format can include displaying the results in a tree format. In the tree format, a tall web page of content can be used, where subsequent responses are contain within indented blocks of text, with vertical lines drawn to indicate which block of text represents a subsequent response to another specific previous response or the origin. In other examples, a tree format and/or indents are not used, yet the organization, such as the topical organization, can be preserved and displayed.

In many embodiments, display module 1122 (FIG. 11) can display the source with a summary of the source. In many embodiments, the summary can be longer and/or more detailed than the snippets that are often displayed in conventional search results.

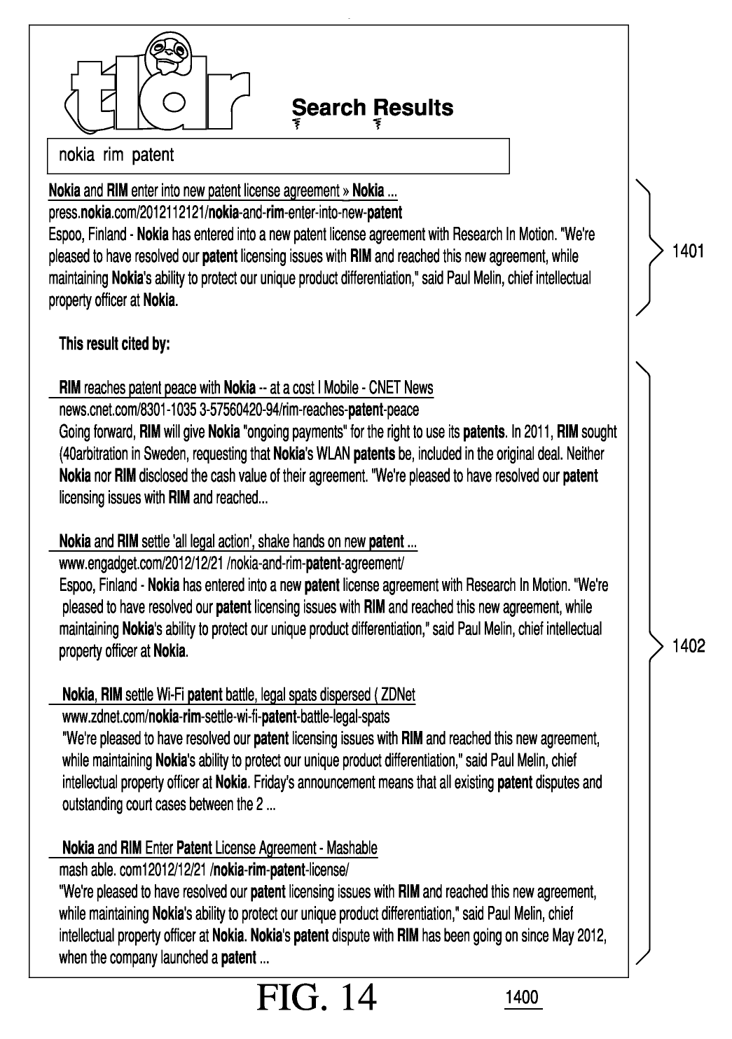

FIG. 14 illustrates an exemplary search results web page 1400 for the “nokia rim patent” search, according to an embodiment. In this example, organization module 1113 (FIG. 11) has organized the search results in a discussion format using a tree format. Specifically, web page 1400, as depicted, includes a source 1401, which is an origin, and sources 1402, which are subsequent responses to the origin.

In another example, displaying the results in a discussion format can include displaying the results using a quotation system. In the quotation system, a subsequent post (including all or portions of the original post or previous responses to which it is a reply) is presented within an indented (or otherwise differently styled) block of text and included in the reply posting. The intention of the quotation system is to alert the reader that the response was inspired by the reply of quoted text.

After procedure 1373, activity 1256 and method 1200 (FIG. 12) can be complete.

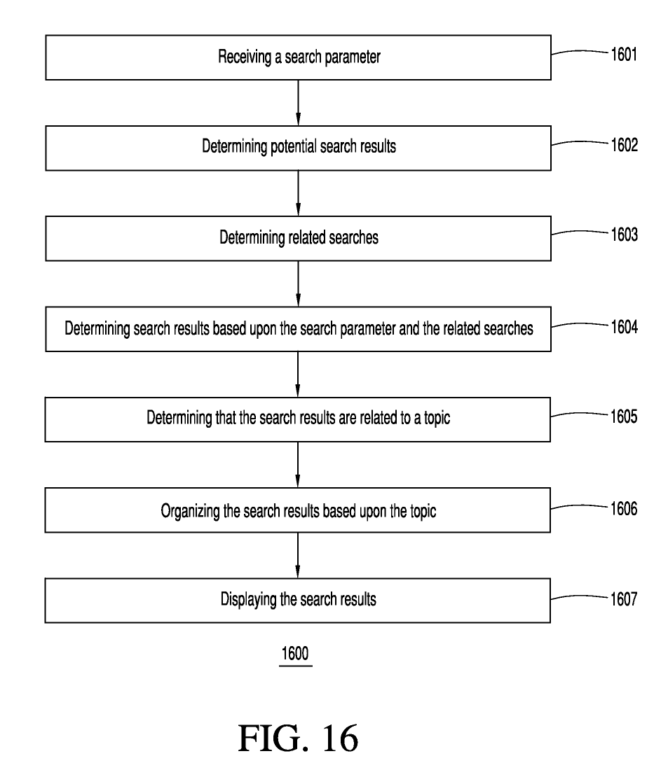

Turning ahead in the drawings, FIG. 16 illustrates a flow chart for a method 1600 of providing two or more search results, according to an embodiment. In some examples, method 1600 also can be considered a method to editorialize results using qualitative traits of the content of search results or a method for displaying information to a user based upon one or more trigger words. Method 1600 also can be considered a method for qualitatively scoring text or textually tagged content or a method of organizing search results.

In some embodiments, method 1600 can apply a multiple step refinement process or feedback loop to determine search results and the organization of the search results based upon the user's purpose in performing the search results. Method 1600 can be similar to method 1200 (FIG. 12) and/or method 1256 (FIG. 13), and various activities of method 1600 can be identical or similar to various activities of method 1200 (FIG. 12) and/or method 1256 (FIG. 13).

Method 1600 is merely exemplary and is not limited to the embodiments presented herein. Method 1600 can be employed in many different embodiments or examples not specifically depicted or described herein. In some embodiments, the activities, the procedures, and/or the processes of method 1600 can be performed in the order presented. In other embodiments, the activities, the procedures, and/or the processes of method 1600 can be performed in any other suitable order. In still other embodiments, one or more of the activities, the procedures, and/or the processes in method 1600 can be combined or skipped.

Referring to FIG. 16, method 1600 can include an activity 1601 of receiving at least one search parameter from a search query of a first user. Activity 1601 can be identical or similar to activity 1251 (FIG. 12) of receiving one or more trigger words. Referring back to FIG. 11, in some examples, one or more of users 1106 and/or 1107 can use a computing device to enter and/or transmit the one or more trigger words to computer system 1100. In many examples, the trigger words are transmitted to computer system 1100 from one or more of users 1106 and/or 1107 over communications network 1105 (e.g., the Internet, or another computer network), as described above.

Method 1600 of FIG. 16 also can include an activity 1602 of determining potential search results based upon the at least one search parameter. In some examples, activity 1602 can be identical or similar to activity 1252 (FIG. 12) of determining potential search results. In various embodiments, preliminary results module 1115 (FIG. 11) can determine potential search results based upon the one or more trigger words. In some examples, preliminary results module 1115 (FIG. 11) can use the trigger words ranked by quantitative scoring, as described above.

Method 1600 also can include an activity 1603 of determining one or more related searches from one or more second users. Activity 1603 can be identical or similar to activity 1253 (FIG. 12). In some embodiments, related search module 1111 (FIG. 11) can be configured to determine one or more related searches from one or more second users 1108 and/or 1109. In various embodiments, activity 1603 can include comparing the at least one search parameter of one or more recent searches to determine the one or more related searches.

Method 1600 also can include an activity 1604 of determining two or more search results at least partially based upon the at least one search parameter and the one or more related searches. Activity 1604 can be identical or similar to activity 1255 (FIG. 12) of determining the search results. In some examples, results module 1114 (FIG. 11) can create a list of best results (i.e., the most relevant results for the user's purpose, etc.) based upon the scores for the potential search results. In various embodiments, activity 1604 can include using the one or more related searches to determine a purpose of the search query of the first user. In several embodiments, activity 1604 can include using the purpose of the search query to determine the two or more search results from three or more potential search results. In some embodiments, using the one or more related searches to determine the purpose of the search query of the first user can include performing natural language processing to the search parameter and two or more search parameters of the one or more related searches to determine the purpose of the search query of the first user.

Method 1600 also can include an activity 1605 of determining that the two or more search results are related to a topic. Activity 1605 can be identical or similar to procedure 1371 (FIG. 13) of determining whether the search is related to a discussion topic. In some examples, topical module 1112 (FIG. 11) can determine if the search results are related to a specific discussion topic. A discussion topic can involve any subject matter. To be a discussion topic, an item can have two or more sources in which the authors of the sources have a conversation about an item, as described above.

Method 1600 also can include an activity 1606 of organizing the two or more search results based upon the topic. Activity 1606 can be identical or similar to procedure 1372 (FIG. 13) of organizing one or more sources in the search results. In some examples, activity 1606 can include organizing one or more elements of the search results based upon the discussion topic. In a number of examples, organization module 1113 (FIG. 11) can organize the search results in a discussion format. Activity 1606 can include organizing the two or more search results into a discussion format. In several embodiments, activity 1606 can include grouping the two or more search results based upon a chronological order of the two or more search results in a discussion of the topic. In certain embodiments, the grouping can be performed independent of an authoritativeness of the two or more search results.

In many embodiments, activity 1606 can include determining an origin of the topic, which can be among the two or more search results. Activity 1606 also can include determining one or more subsequent responses to the origin of the topic, in which the subsequent responses can be among the two or more search results. In a number of embodiments, activity 1606 also can include displaying the origin of the topic to the first user, and after displaying the origin of the topic, displaying the one or more subsequent responses to the first user. In certain embodiments, the origin of the topic and the subsequent responses can be displayed to the first user via a search results web page, such as search results web page 1400 (FIG. 14), such as by displaying the origin of the topic before the one or more subsequent responses, as shown in FIG. 14. Alternatively, or in addition to, activity 1606 in FIG. 16 can involve organization module 1113 (FIG. 11) grouping the two or more search result based upon a chronological order of the two or more search results in a discussion of the topic.

Method 1600 also can include an activity 1607 of displaying the two or more search results to the first user. Activity 1607 can be identical or similar to procedure 1373 (FIG. 13) of displaying the search results to the user. In some examples, activity 1607 can include visually displaying the search results to the user on a web page. In some examples, display module 1122 (FIG. 11) can communicate the search results in a predetermined format (e.g., a web page) to one or more of users 1106 and/or 1107 (FIG. 11) via communications network 1105. In many examples, the search results can be visually displayed by display module 1122 (FIG. 11) using a display on a computing device of one or more of users 1106 and/or 1107.

In some examples, activity 1607 can include displaying the two or more search results to the first user in the discussion format. In a number of embodiments, a presentation order of the two or more results in the discussion format can be organized independent of a score for each of the two or more search results. In several embodiments, the score for each of the two or more search results can be based upon a relevance of a search results to the at least one search parameter.

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that activities 251-258 of FIG. 2, procedures 471-474 of FIG. 4, procedures 771-772 of FIG. 7, activities 1251-1256 of FIG. 12, procedures 1371-1373 of FIG. 13, and activities 1601-1607 of FIG. 16 may be comprised of many different activities, procedures and be performed by many different modules, in many different orders, that any element of FIGS. 1-16 may be modified, and that the foregoing discussion of certain of these embodiments does not necessarily represent a complete description of all possible embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A method for providing two or more search results, the method being implemented via execution of computer instructions configured to run at one or more processing modules and configured to be stored at one or more non-transitory memory storage modules, the method comprising:
receiving at least one search parameter from a search query of a first user;
determining potential search results based upon the at least one search parameter;
determining one or more related searches from one or more second users;
determining two or more search results at least partially based upon the at least one search parameter and the one or more related searches;
determining that the two or more search results are related to a topic;
organizing the two or more search results based upon the topic; and
displaying the two or more search results to the first user.

2. The method of claim 1, wherein:
determining the one or more related searches comprises comparing the at least one search parameter with one or more search parameters of one or more recent searches to determine the one or more related searches.

3. The method of claim 1, wherein:
determining the two or more search results comprises:
using the one or more related searches to determine a purpose of the search query of the first user; and
using the purpose of the search query to determine the two or more search results from three or more potential search results.

4. The method of claim 3, wherein:
using the one or more related searches to determine the purpose of the search query of the first user comprises:
performing natural language processing to the at least one search parameter and to one or more search parameters of the one or more related searches to determine the purpose of the search query of the first user.

5. The method of claim 1, wherein:
organizing the two or more search results based upon the topic comprises organizing the two or more search results into a discussion format; and
displaying the two or more search results to the first user comprises displaying the two or more search results to the first user in the discussion format.

6. The method of claim 5, wherein:
a presentation order of the two or more search results in the discussion format are organized independent of a score for each of the two or more search results; and
the score for each of the two or more search results is based upon a relevance of a search result to the at least one search parameter.

7. The method of claim 5, wherein:
organizing the two or more search results into the discussion format comprises grouping the two or more search results based upon a chronological order of the two or more search results in a discussion of the topic.

8. The method of claim 7, wherein:
the grouping is performed independent of an authoritativeness of the two or more search results.

9. The method of claim 1, wherein:
organizing the two or more search results based upon the topic comprises:
determining an origin of the topic, wherein the two or more search results comprise the origin of the topic; and
determining one or more subsequent responses to the origin of the topic, wherein the two or more search results comprise the one or more subsequent responses;
and
displaying the two or more search results to the first user comprises:
displaying the origin of the topic to the first user; and
after displaying the origin of the topic, displaying the one or more subsequent responses to the first user.

10. The method of claim 9, wherein:
displaying the origin of the topic to the first user and displaying the one or more subsequent responses to the first user comprise:
displaying to the first user a search results web page having the origin of the topic and the one or more subsequent responses, wherein the origin of the topic is displayed before the one or more subsequent responses on the search results web page.

11. The method of claim 1 comprising:
determining environmental information related to the at least one search parameter,
wherein:
determining the two or more search results comprises determining the two or more search results at least partially based upon the environmental information.

12. A method for providing two or more search results, the method being implemented via execution of computer instructions configured to run at one or more processing modules and configured to be stored at one or more non-transitory memory storage modules, the method comprising:
receiving one or more trigger words from a first user;
determining potential search results based upon the one or more trigger words;
determining one or more related searches from one or more second users;
determining environmental information related to the one or more trigger words;
determining two or more search results at least partially based upon the one or more trigger words, the one or more related searches, and the environmental information; and
communicating the two or more search results to the first user.

13. The method of claim 12, wherein:
communicating the two or more search results to the first user comprises:
determining that the two or more search results are related to a topic;
organizing the two or more search results based upon the topic; and
displaying the two or more search results to the first user.

14. The method of claim 13, wherein:
organizing the two or more search results based upon the topic comprises organizing the two or more search results into a discussion format; and
displaying the two or more search results to the first user comprises displaying the two or more search results to the first user in the discussion format.

15. The method of claim 13, wherein:
organizing the two or more search results based upon the topic comprises:
determining an origin of the topic, wherein the two or more search results comprise the origin of the topic; and
determining one or more subsequent responses to the origin of the topic, wherein the two or more search results comprise the one or more subsequent responses;
and
displaying the two or more search results to the first user comprises:
displaying the origin of the topic to the first user; and
after displaying the origin of the topic, displaying the one or more subsequent responses to the first user.

16. A system configured to generate search results from three or more sources based upon one or more trigger words received from a first user, the system comprising:
one or more processing modules; and
one or more non-transitory memory storage modules storing computing modules configured to run on the one or more processing modules, the computing modules comprising:
a communications module configured to receive the one or more trigger words from the first user and to communicate the search results to the first user;
a related search module configured to determine one or more related searches from one or more second users;
a results module configured to determine the search results based upon the one or more trigger words and the one or more related searches, the search results comprising at least two sources from the three or more sources;
a topical module configured to determine that the two or more search results are related to a topic;
an organization module configured to organize the two or more search results based on the topic; and
a display module configured to display the two or more search results to the first user.

17. The system of claim 16, wherein:
the organization module is further configured to organize the two or more search results into a discussion format.

18. The system of claim 17, wherein:
the display module is further configured to display the two or more search results to the first user in the discussion format.

19. The system of claim 16, wherein:
the organization module is further configured to:
determine an origin of the topic, wherein the two or more search results comprise the origin of the topic; and
determine one or more subsequent responses to the origin of the topic, wherein the two or more search results comprise the one or more subsequent responses;
and
the display module and the organization module are further configured to:
display the origin of the topic to the first user; and
after displaying the origin of the topic, display the one or more subsequent responses to the first user.

20. The system of claim 16, wherein the computing modules comprise:
an environmental module configured to determine environmental information related to the one or more trigger words,
wherein:
the results module is further configured to determine the search results based upon the environmental information.
